(19) United States
(12) Patent Application Publication
(10) Pub. No.: US 2018/0268635 A1
(43) Pub. Date: Sep. 20, 2018

(54) System and Method for Coin Roll Wrapper Crimp Modification

(71) Applicant: Michael Marok, Bovey, MN (US)

(72) Inventor: Michael Marok, Bovey, MN (US)

(21) Appl. No.: 15/922,751

(22) Filed: Mar. 15, 2018

Related U.S. Application Data
(60) Provisional application No. 62/473,037, filed on Mar. 17, 2017.

(51) Int. Cl. G07D 9/06; G07D 9/00

(52) U.S. Cl. CPC G07D 9/065; G07D 9/006

(57) ABSTRACT

A coin roll crimp includes an indentation along a circumference portion of the crimp, the indentation formed by cutting or tearing the circumference portion of the crimp from the body of a coin roll wrapper proximate the end of the base of the circumference portion of the crimp.

### RELATED APPLICATIONS

This application is related to and claims priority from pending U.S. provisional patent application Ser. No. 62/473,037 filed Mar. 17, 2017, entitled Coin Roll Cutter and Cutting Method, which is hereby incorporated by reference herein for all purposes.

### FIELD OF THE DISCLOSURE

The invention relates generally to a system and method for modifying a coin roll wrapper crimp to help promote ease of opening of the coin roll, and more particularly to a modified crimp including a crimp indentation formed along a circumference portion of the crimp, wherein the indentation includes a crimp portion that is cut or torn from the wrapper body at the base of the crimp portion.

### BACKGROUND

Coin rolling equipment is well known within the prior art. In the US, coins most commonly are rolled in paper wrappers, with pennies and dimes rolled in stacks of 50 coins and nickels and quarters rolled in stacks of 40 coins. The paper roll typically encircles the coin stack one and a half (1½) to two and a half (2½) times, i.e., 540° to 900°. In rolling coins, the ends of the paper extend one quarter (¼) to one half (½) inch past each end of the coin stack, and then the ends are rolled under. This rolling under of the ends of the paper creates a “crimp” that extends lengthwise beyond the last coin and circumferentially about the stack adjacent the outer face of the end coin. Thus, the paper and coins are held in place by the crimp.

Such paper coin rolls are well known to consumers. As shown in FIG. 1, coin rolls 10 may come in a variety of sizes based on the size and number of coins rolled together. A crimp 20 is at each end of the coin roll to hold the coins and wrapper in place. In greatly enlarged cross section, the end of a coin roll may resemble the exemplary configuration shown in FIG. 2. The coin wrapper crimp averages about 0.05 to 0.1 inches in width w, extending about 0.1 to 0.15 inches in length 1 beyond the end coin 25. The crimp 30 is joined to the wrapper main body 40 at an end 60 of crimp base 50.

While such coin rolls are convenient for transportation, storage and counting of coins, they are difficult for most individuals to open. The most common way for an individual to open a coin roll is to bang the coin roll on a corner surface, such as on the corner of a counter, a conveyor belt, or a till near a check-out location where the coins are needed. This banging method of opening coin rolls is very abusive to the counter/conveyor belt/till corner, often leaving chips or mars in whatever corner is used. Thus, a new and improved system and method is needed to help promote the opening of coin rolls.

### SUMMARY

The present disclosure provides systems and methods that help promote the opening of coin rolls. In one exemplary embodiment, a system and method is provided for modifying a coin roll wrapper crimp to help promote ease of opening of the coin roll. More particularly, in one exemplary embodiment, a modified crimp is formed including a crimp indentation along a circumference portion of the crimp, wherein the indentation includes a crimp portion that is cut or torn from the wrapper body at the base of the crimp portion. A coin roll with a modified crimp may be opened by holding the crimp indentation and tearing the crimp from the wrapper body, enabling the wrapper to be easily removed for access to the coin stack.

An exemplary system for modifying a crimp may include a handle portion that when operated urges an end of the coin roll against a portion of a crimp modifying block to form a crimp indentation.

Other benefits and advantages of the present disclosure will be appreciated from the following detailed description.

### DESCRIPTION OF THE DRAWINGS

FIG. 1 is a perspective view of exemplary coin rolls.

FIG. 2 is a sectional view of an end portion of an exemplary coin roll.

FIG. 3 is a perspective view of an exemplary modified coin roll including a crimp indentation formed along a circumference portion of the crimp, wherein the indentation includes a crimp portion that is cut or torn from the wrapper body at the base of the crimp portion.

FIG. 4 is a perspective view of the exemplary embodiment of coin roll modifier system.

FIG. 5 is a perspective view of the exemplary embodiment of coin roll modifier system shown in FIG. 4.

FIG. 6 is a perspective view of the exemplary embodiment of coin roll modifier system shown in FIG. 4 in an operating orientation with, among other things, a handle pulled forward.

FIG. 7 is a perspective view of the exemplary embodiment of the coin roll modifier system shown in FIG. 6.

FIG. 8 is a perspective view of the exemplary embodiment of coin roll modifier system shown in FIG. 4 with a cover removed.

FIG. 9 is a perspective view of the exemplary embodiment of a of coin roll modifier system shown in FIG. 8.

FIG. 10 is a perspective view of the exemplary embodiment of coin roll modifier system shown in FIG. 8, in an operating orientation with, among other things, a handle pulled forward.

FIG. 11 is a perspective view of the exemplary embodiment of a of coin roll modifier system shown in FIG. 10.

FIG. 12 is a perspective view of the exemplary embodiment of coin roll modifier system shown in FIG. 8 with a handle removed.

FIG. 13 is a perspective view of the exemplary embodiment of coin roll modifier system shown in FIG. 10 with a handle removed.

FIG. 14 is a perspective view of the exemplary embodiment of a of coin roll modifier system shown in FIG. 12.

FIG. 15 is a perspective view of the exemplary embodiment of a of coin roll modifier system shown in FIG. 13.

FIG. 16 is a partial assembly view of the exemplary embodiment of a coin roll modifier system shown in FIG. 12.

FIG. 17 is a second partial assembly view of the exemplary embodiment of a coin roll modifier system shown in FIG. 12.

FIG. 18 is a third partial assembly view of the exemplary embodiment of a coin roll modifier system shown in FIG. 12.

FIG. 19 is a cross sectional view of a coin roll positioned relative to an upper crimp modification block for modification.

FIG. 20 is a cross sectional view of a coin roll that has moved downward to engage an upper crimp modification block and form a modified crimp.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to crimp modification; etc. Such aspects related to this disclosure do not depart from the invention, and it is therefore intended that the invention not be limited by the certain aspects set forth of the events and circumstances related to this disclosure.

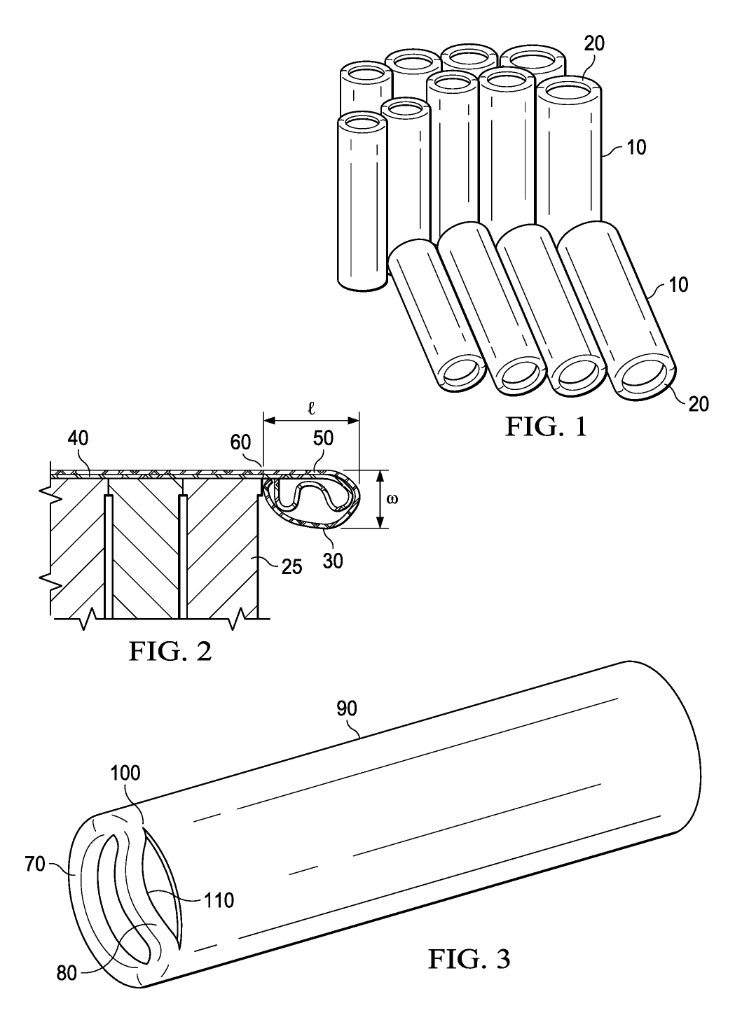

Turning now to the drawings, FIG. 1 shows a variety of coin rolls 10 of various sizes. Each coin roll 10 includes a crimp 20 on each end of the coin roll 10. An exemplary crimp is described in FIG. 2. The coin wrapper main body 40 joins the base 50 of crimp 30 at end 60.

An exemplary modified crimp 70 is shown in FIG. 3. A crimp portion 80 forms an indentation along a circumference portion of the crimp 70, wherein the indentation includes a crimp portion that is cut or torn from the wrapper body 90 at the end 100 of the base 110 of the crimp portion. A coin roll with a modified crimp 70 may be opened by holding the crimp indentation and tearing the crimp 70 from the wrapper body 90, enabling the wrapper body 90 to be easily removed for access to the coin stack. As used herein, a crimp “indentation” is formed by moving inwardly toward the central longitudinal axis of a coin roll a crimp circumference portion. The circumference portion may be cut or torn from the body of a coin roll wrapper at the base of the circumference portion.

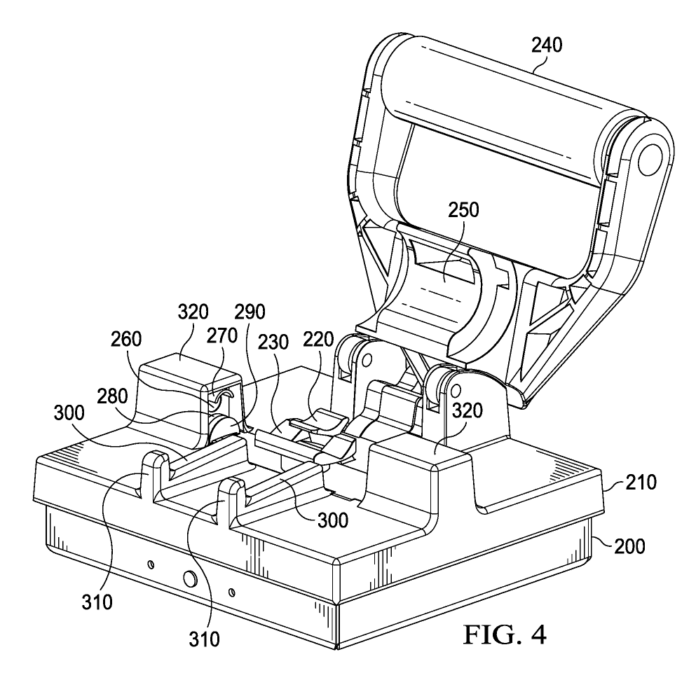

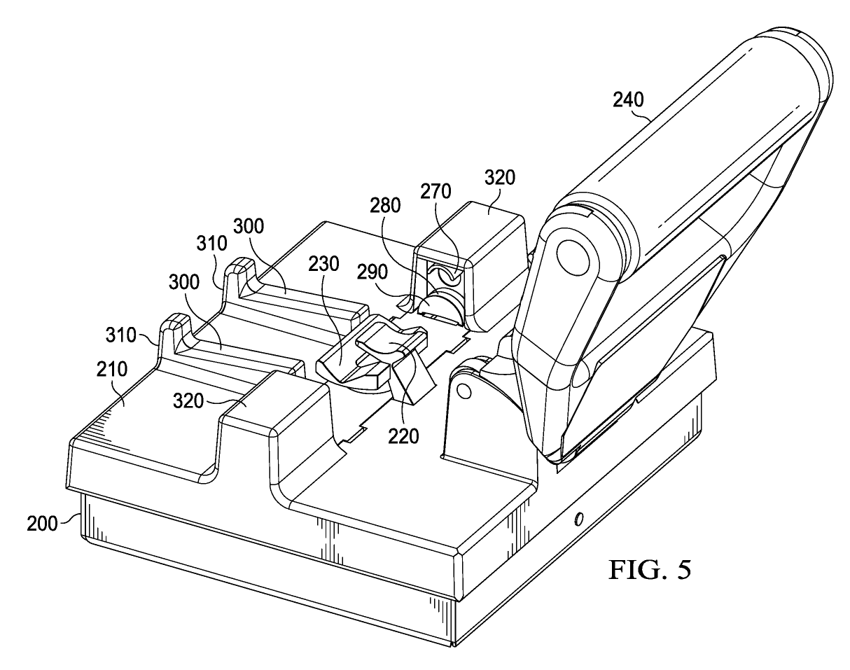

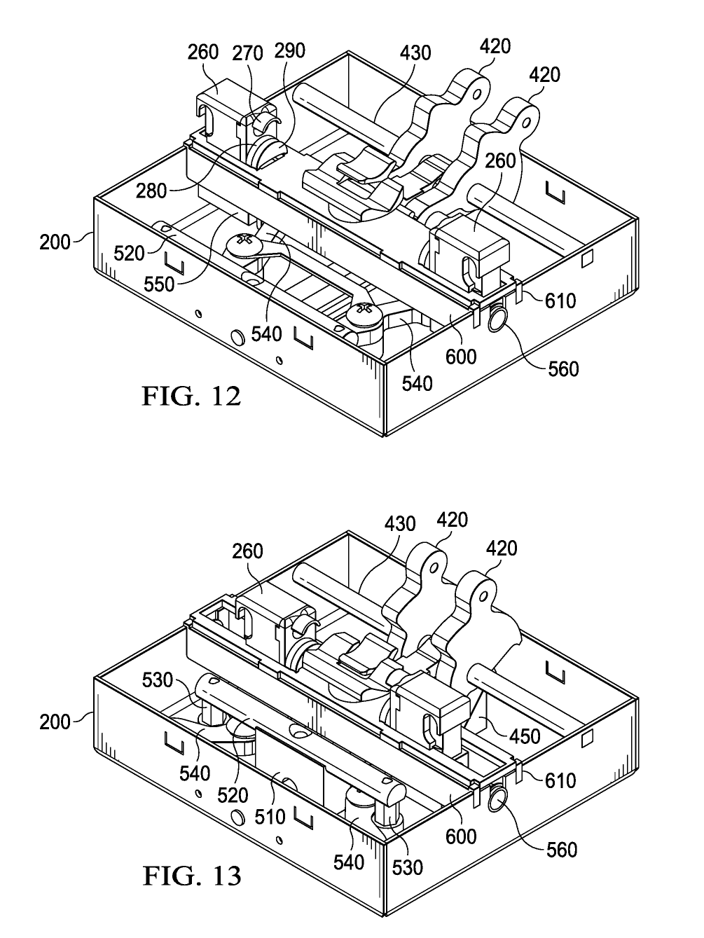

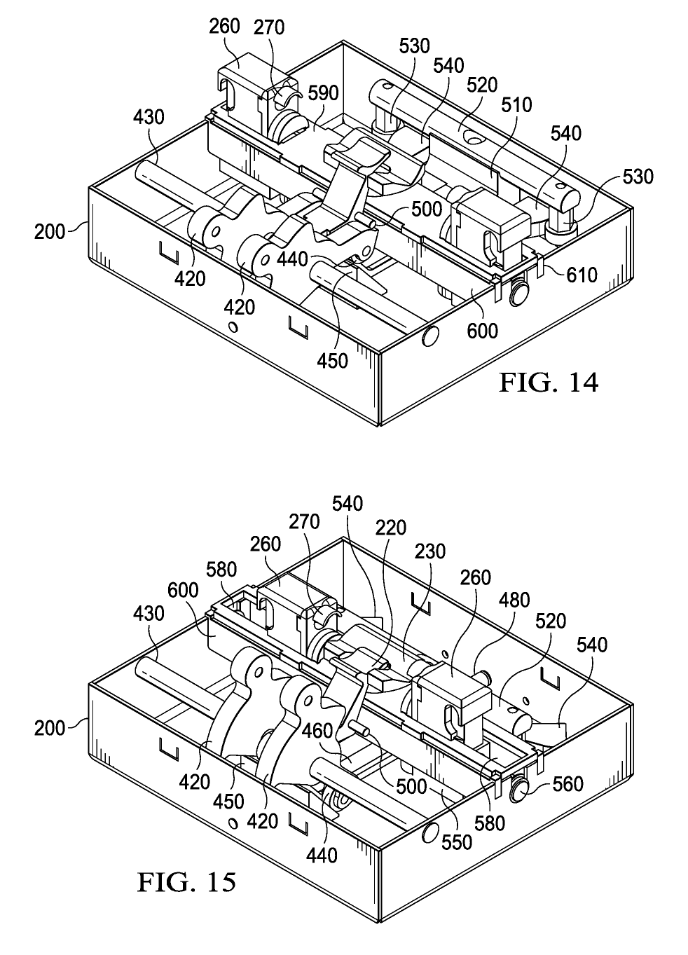

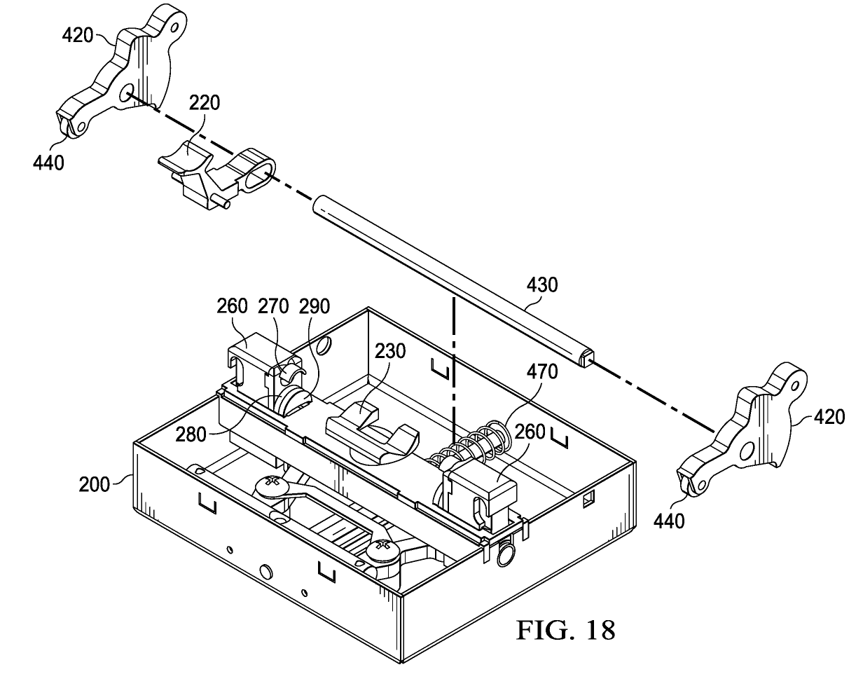

An exemplary system for creating a modified crimp is shown in FIGS. 4-18. As shown in FIGS. 4-7, the system includes a housing 200 and a cover 210. Generally centrally disposed above a portion of the cover 210 is an ejector 220 and cradle 230 for receiving a roll of coins. When a roll of coins is placed in the cradle 230, a handle 240 hingedly attached to the cover 210 may be pulled forward and downwardly, so that a seat 250 of handle 240 engages the upper surface of the coin roll in the cradle 230. As the handle 240 is pulled forward, a pair of upper crimp modifying blocks 260 move inwardly to engage the outer faces of the end coins of the coin roll. Upper crimp modifying block 260 includes a post 270 that engages the outer face of the end coin. The upper block 260 also includes a separator 280 with an end 290. When the post 270 engages the outer face of the end coin of the coin roll disposed in the cradle 230, the separator end 290 is positioned beneath the end of the base of the crimp of the coin roll disposed in the cradle 230.

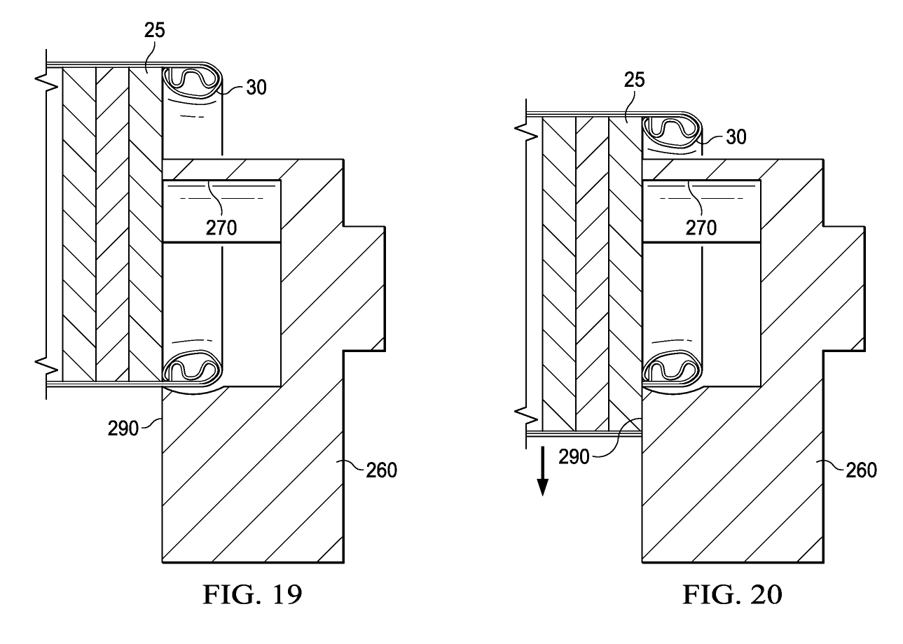

As the handle 240 is pulled forward and downwardly, the seat 250 of handle 240 engages the upper surface of the coin roll in the cradle 230, so that the coin roll is pushed downwardly. As the coin roll moves downward, the end of the base of the crimp of the coin roll engages the upper portion of separator 280 to form a crimp indentation. The crimp of the coin roll along a portion of its circumference separates from the main body of the coin wrapper at the end of the crimp base. Separation may occur due to cutting, tearing, or a combination of cutting and tearing of the coin roll wrapper. See also FIGS. 19-20.

Once the crimp indentation is formed, the handle 240 is moved upwardly and back. This movement causes the ejector 220 to move upwardly and push the modified coin roll out of the cradle 230 and onto a pair of sloped surfaces 300. The modified coin roll travels along the sloped surfaces 300 until the modified coin roll hits the stops 310 at the lower end of the sloped surfaces 300.

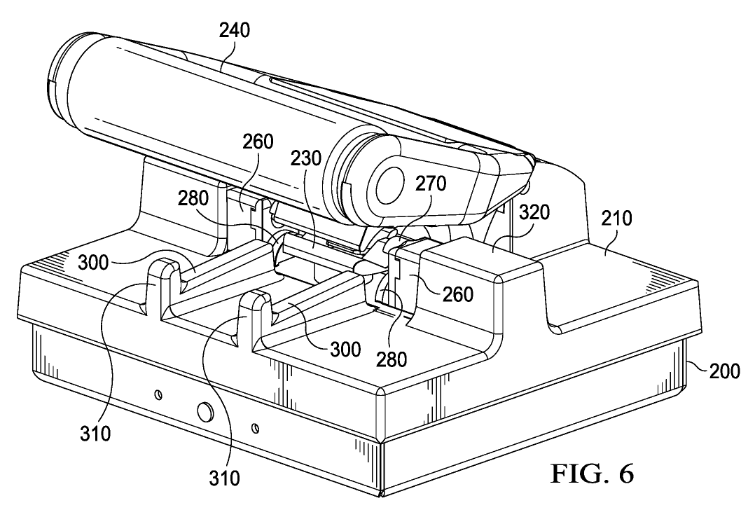

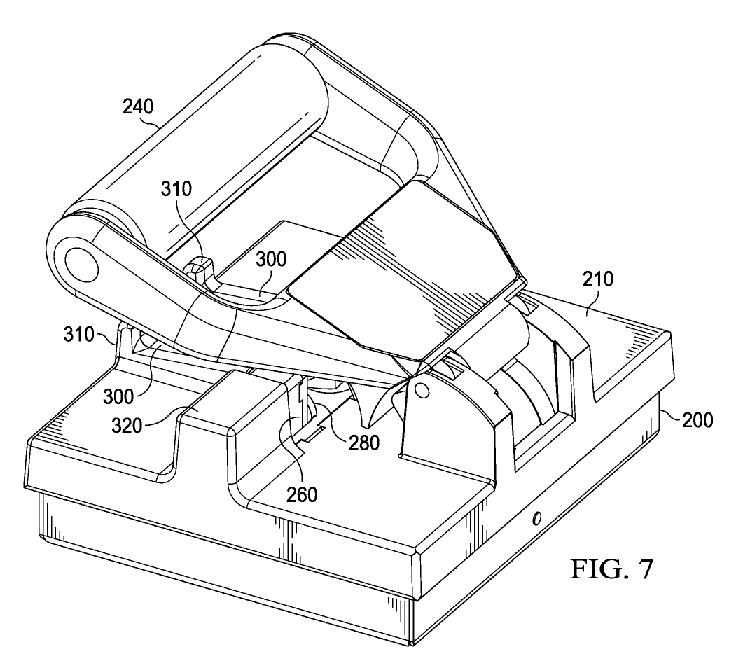

FIGS. 4-5 shown the crimp modification system in an “open” configuration ready to receive a roll of coins at cradle 230. In this configuration, among other things, the upper crimp modifying blocks 260 are positioned outwardly and under portions 320 of cover 210. FIGS. 6-7 show the crimp modification system in a “closed” configuration that forms the crimp indentation after the upper crimp modifying blocks have moved inwardly to the outer face of the end coin of the coin roll. For clarity, the coin roll is not shown in FIGS. 4-14.

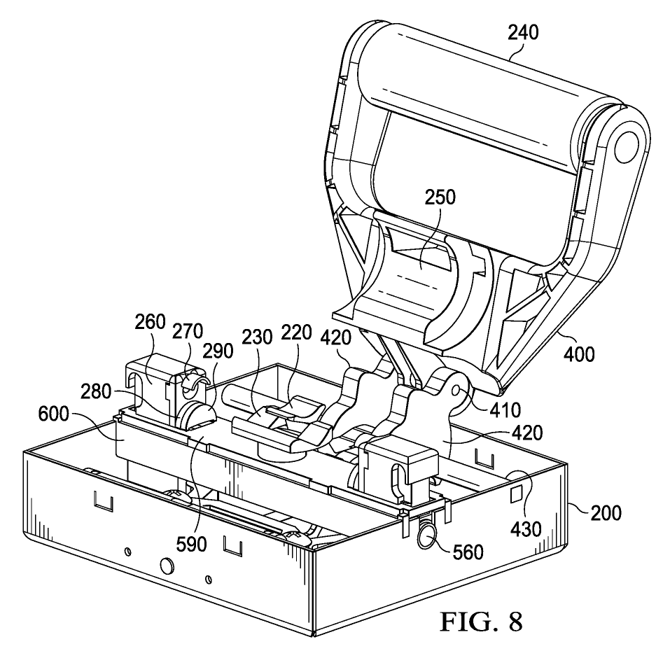

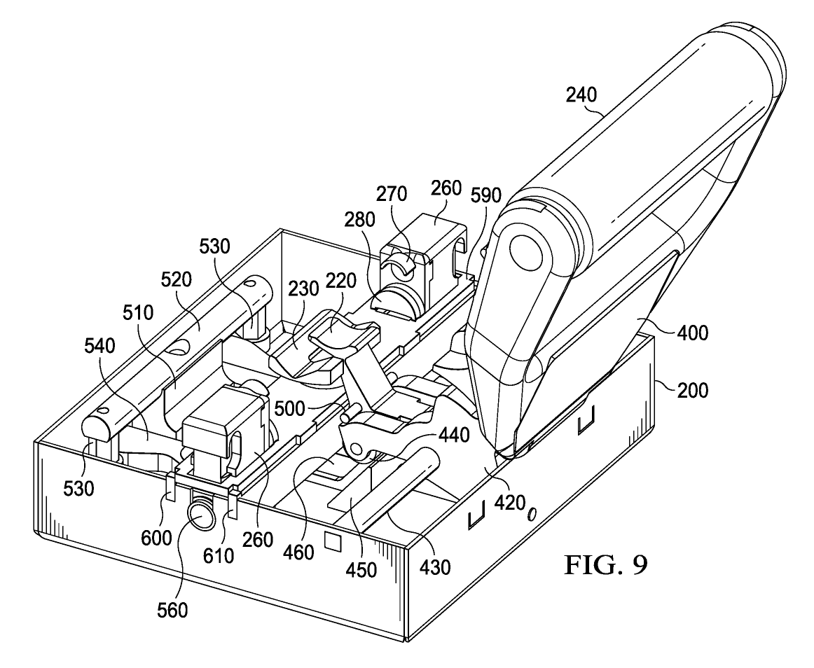

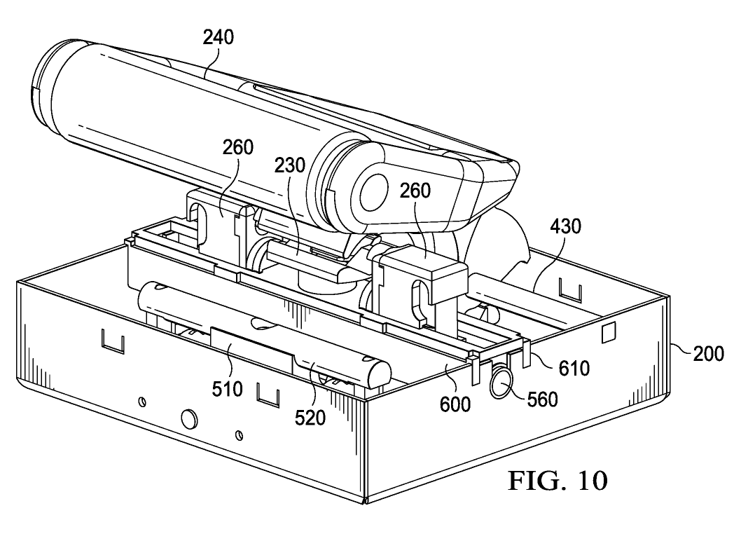

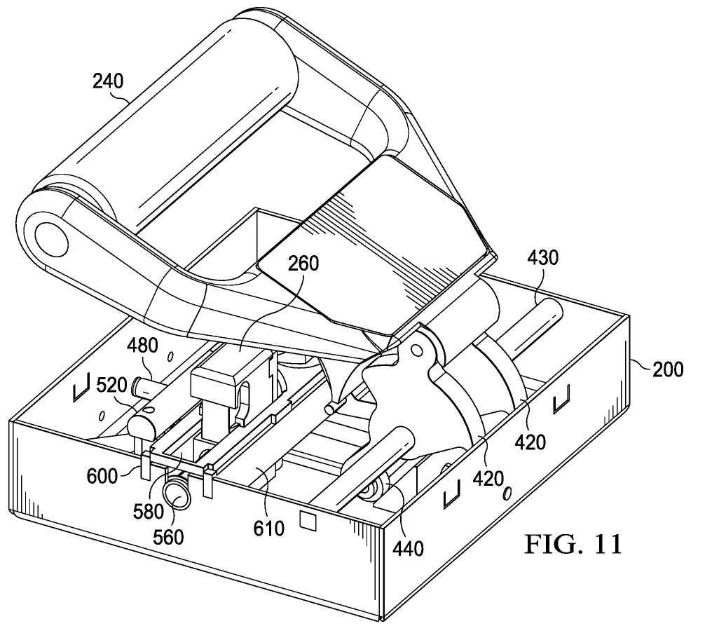

FIGS. 8-11 show the exemplary crimp modification system in an open configuration (FIGS. 8-9) and closed configuration (FIGS. 10-11) with the cover 210 removed. As shown in the drawings, handle 240 including handle body 400 may rotate about a pin 410. The pin 410 links the handle 240 at the handle body 400 to a pair of levers 420 that rotate about a fixed pivot corresponding to shaft 430. The end of each lever 420 opposite the pin 410 includes a roller 440. As the handle 240 is pulled forward and downwardly, the rollers 440 engage a triangularly shaped wedge portion 450 of puller 460. The rollers 440 travel downwardly along the surface of portion 450, urging the puller 460 backward against the action of compression spring 470 disposed about puller shaft 480 along which the puller 460 travels. Also, as the handle 240 is pulled downwardly and forwardly, pin 500 of ejector 220 loses contact with the levers 420 proximate the rollers 440, allowing the ejector to rotate about shaft 430 so that the forward end of ejector 220 moves downwardly to permit a coin roll to settle into cradle 230. Conversely, as the handle 240 is pushed upwardly and back, the lever 420 proximate roller 440 pushes the pin 500 upwardly so that the end of the ejector 220 opposite shaft 430 forces a coin roll out of cradle 230 and onto the sloped surfaces 300 of cover 210.

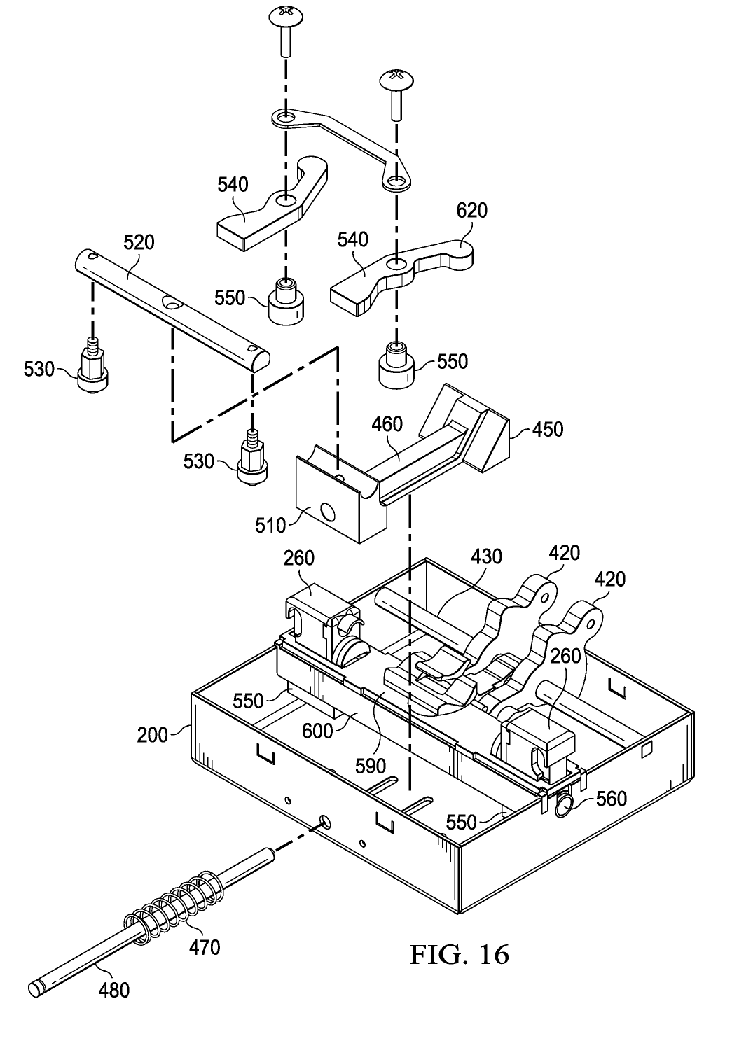

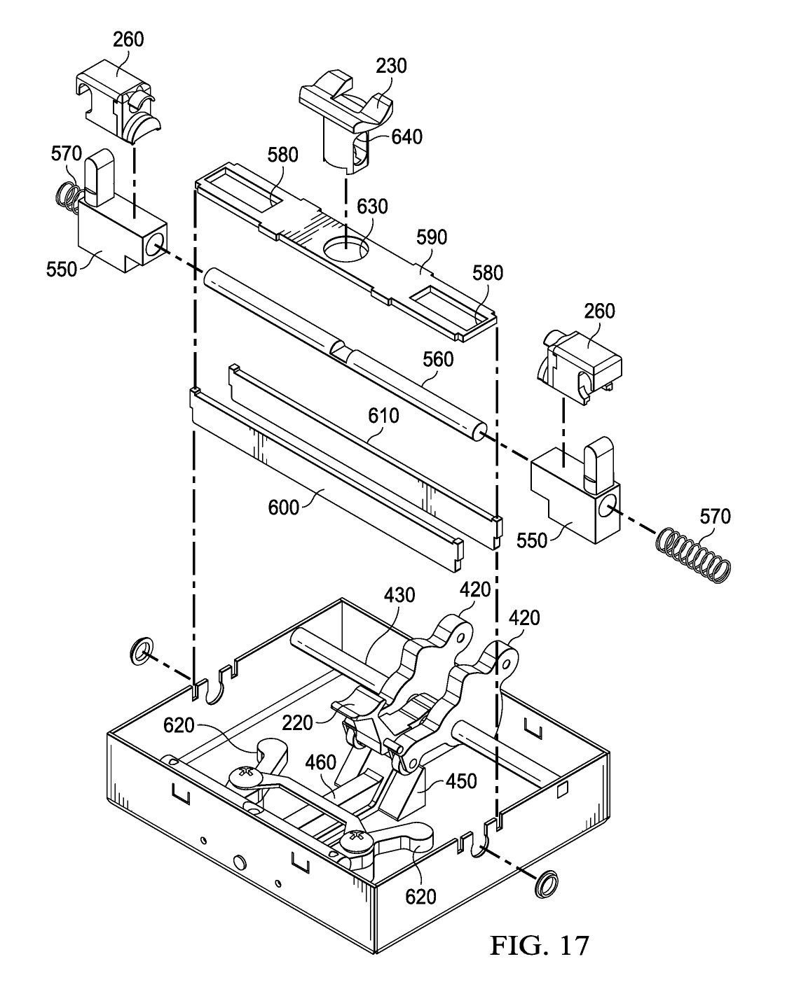

As shown in FIG. 16, the puller 460 at one, rear end includes triangularly shaped wedge portion 450 and at the opposite, forward end includes a puller block 510. The puller block 510 is coupled to puller shaft 520, e.g., with a screw, bolt, or other suitable fastening means. At each end of puller shaft 520 is a follower post 530. A pair of puller levers 540 each may pivot about a fixed pivot corresponding to post 550 rigidly fixed to the bottom of housing 200. At one, forward end each of the puller levers 540 engage a follower post 530. As the puller 460 moves back and forth, the follower posts move back and forth and the puller levers 540 rotate due to the contact with the follower posts 530 along the shape of the puller levers 540. Each end 620 of the puller levers 540 opposite the follower posts 530 engages a lower crimp modifying block 550 that is attached to upper crimp modifying block 260. See FIG. 17.

As shown in FIG. 17, the upper crimp modifying block 260 and the lower crimp modifying block 550 may move together along central shaft 560 extending between the sides of housing 200. Each compression block spring 570 extends between lower crimp modifying block 550 and a side of housing 200. The block springs 570 urge the lower crimp modifying blocks 550 inwardly, away from the sides of housing 200. The upper modifying blocks 260 move with the lower modifying blocks 550. Each of the upper blocks 260 travel in a slot 580 formed in bridge top 590. Each of the lower modifying blocks 550 move under the bridge top 590 and between bridge sides 600, 610. The bridge top 590 and bridge sides 600, 610 prevent the lower modifying blocks 550 from rotating about central shaft 560.

When the crimp modifying system is in the open configuration, the ends 620 of puller levers 540 place the lower modifying blocks 550 in their outermost positions proximate the sides of housing 200. As the crimp modifying system assumes a closed configuration, the handle 240 moves forward and downwardly, causing the puller 460 to move rearwardly. Each of the follower posts 530 moves rearwardly as well along the shape of a puller lever 540. The variation in shape of a puller lever 540 allows each puller lever 540 to rotate about a post 550 under the action of springs 570. The travel of the follower posts 530 along the shape of puller lever 540 allows the lower modifying block 550 to move inwardly due to the action of spring 570 until the post 270 of upper modifying block 260 abuts the outer face of an end coin of a coin roll disposed in cradle 230.

As shown in FIG. 17, the cradle 230 may move up and down through the central opening 630 of bridge top 590 due to slot 640 through which central shaft 560 passes. A spring disposed between central shaft 560 and cradle 230 may urge the cradle 230 upwardly. When the crimp modifying system is in an open configuration, the cradle 230 may be disposed in its uppermost position. The cradle 230 may be disposed in its lowermost position when the modified crimp is formed as a result of the handle seat 250 pushing the coin roll downwardly against the uppermost edges of the ends 290 of upper modifying blocks 260. See FIGS. 19-20.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

By way of example only, and without limitation, a crimp may be provided including a base that is perforated at its end, i.e., where the crimp base joins the main body of a coin wrapper. In such a configuration an indentation may or may not be provided. Opening the coin roll may be achieved by simply tearing or cutting the crimp from the coin roll at the perforation.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. A coin roll crimp including an indentation along a circumference portion of the crimp.

2. The coin roll crimp of claim 1, wherein the indentation includes a crimp portion that is cut or torn from a coin roll wrapper body at the base of the crimp portion.

3. A method comprising: (a) providing a coin roll with a crimp, and (b) indenting the crimp along a circumference portion of the crimp.

4. The method of claim 3, wherein the step of indenting includes cutting or tearing a crimp portion from a coin roll wrapper body at a base of the crimp portion.

5. The method of claim 4 wherein the coin roll is moved downwardly and the cutting or tearing occurs as the crimp portion contacts a lower crimp modifying block.

6. The method of claim 5, including the step of positioning the lower crimp modifying block beneath the crimp portion so that an end of the lower crimp modifying block is proximate the end of the base of the crimp portion.

7. The method of claim 6, wherein the positioning step includes the step of moving a post of an upper crimp modifying block against an outer face of a coin adjacent the crimp.

8. A method comprising: (a) providing a coin roll with a wrapper main body and a crimp; and (b) cutting or tearing the crimp away from the wrapper main body.

9. The method of claim 8, wherein perforations are disposed between the wrapper main body and the crimp.

10. The method of claim 8, wherein a circumference portion of the crimp is indented.

11. The method of claim 10, wherein the circumference portion of the crimp has been cut or torn from the wrapper main body.
